(19) United States
(12) Patent Application Publication
(10) Pub. No.: US 2023/0135141 A1
(43) Pub. Date: May 4, 2023

(54) ANTENNA HEATER AND METHODS FOR PREVENTING ICE FORMATION ON ELECTROMAGNETIC WAVE ANTENNAS

(71) Applicant: Amphenol Thermometrics, Inc., St. Marys, PA (US)

(72) Inventors: John D. Seaton, Taunton (GB); Michael J. Roberts, Taunton (GB); Christopher P. Kinder, Taunton (GB); David R. Tolman, Taunton (GB)

(21) Appl. No.: 17/516,317

(22) Filed: Nov. 1, 2021

(51) Int. Cl. H01Q 1/02; H05B 3/06; H05B 1/02

(52) U.S. Cl. CPC H01Q 1/02; H05B 3/06; H05B 1/023; H05B 2203/02; H05B 2203/016

(57) ABSTRACT

An antenna heater for heating an antenna includes a heating panel that is configured for attachment to the antenna and comprising heating tracks. The heating tracks are spaced apart from each other and each includes an electrically-conductive trace and positive temperature coefficient (PTC) elements. The PTC elements are electrically connected to the electrically-conductive trace, spaced apart along the electrically-conductive trace, and made of a PTC material having an equilibrium temperature greater than 0° C.

### FIELD

This disclosure relates generally to electromagnetic wave antennas, and more particularly to preventing ice formation on such antennas.

### BACKGROUND

Antennas may be used to transmit data to or receive data from other transmission devices via electromagnetic waves. Often times, an antenna requires a fairly unobstructed path between the antenna and the data transmission devices for the most efficient transmission of data. Accordingly, antennas are often located in geographic locations where relatively long-range unobstructed paths are more prevalent, such as high altitude, remote, and/or low-temperature or freezing locations.

Although positioning an antenna at a high altitude, remote, and/or low-temperature or freezing locations can promote data transmission over long ranges, these locations often experience harsh environmental conditions that can disrupt the ability of the antenna to effectively transmit data. For example, in cold weather environments, ice may form on the antennas, which can attenuate the electromagnetic waves transmitted from or received by the antenna.

Conventional approaches for reducing the formation of ice on an electromagnetic wave antenna have various shortcomings. According to one approach, a large mechanical shield or overhang is positioned above the antenna to redirect or catch snow and ice to prevent the snow or ice from falling onto the antenna. However, these mechanical shields may fail to prevent snow or ice from contacting the antenna from the side (e.g., in high-wind situations in which the snow or other precipitations contacts the antenna despite the mechanical shield) and may fail to effectively prevent the accretion of ice on the antennas. Another approach includes wrapping an antenna in a large bag made of a low-friction material, which is intended to prevent ice accretion on the bag and thus on the antenna.

These passive approaches are not efficient or reliable at preventing the accumulation of snow or formation of ice on an antenna. Moreover, installing large mechanical shields and bags on an antenna in the field is a difficult task that often requires at least two technicians. Additionally, large mechanical shields and bags on an antenna add significant weight and wind resistance to structures supporting the antenna.

### SUMMARY

The subject matter of the present application has been developed in response to the present state of the art, and, in particular, in response to the problems and needs of conventional devices and methods of addressing the accumulation of snow, the formation of ice, or both on an antenna or multiple antennas. The subject matter of the present application may reduce or prevent the accumulation of snow and/or the formation of ice on an electromagnetic wave antenna in an efficient and reliable manner, and may also be easy to install such that, in some cases, it may be installed by a single technician In view of the foregoing, the subject matter of the present application has been developed to provide an antenna heater and corresponding methods, that overcome at least some of the shortcomings of the prior art.

Disclosed herein is an antenna heater for heating an antenna comprising heating panel, configured for attachment to the antenna and comprising heating tracks. The heating tracks are spaced apart from each other and each comprises an electrically-conductive trace and positive temperature coefficient (PTC) elements. The PTC elements are electrically connected to the electrically-conductive trace, spaced apart along the electrically-conductive trace, and made of a PTC material having an equilibrium temperature greater than 0° C. The preceding subject matter of this paragraph characterizes example 1 of the present disclosure.

The heating panel further comprises an outer cover and an inner cover that is spaced apart from the outer cover such that a gap is defined between the outer cover and the inner cover. The heating tracks are fixed to one of the outer cover or the inner cover, and are located within the gap. The preceding subject matter of this paragraph characterizes example 2 of the present disclosure, wherein example 2 also includes the subject matter according to example 1, above.

The antenna heater further comprises a gasket between the outer cover and the inner cover. The gasket seals the gap and defines the outer periphery of the heating panel. The preceding subject matter of this paragraph characterizes example 3 of the present disclosure, wherein example 3 also includes the subject matter according to example 2, above.

The outer cover and the inner cover are disk-shaped. A shape of the outer periphery of the heating panel is circular. A shape of the first clamp arm is a semi-circle. A shape of the second clamp arm is a semi-circle. The preceding subject matter of this paragraph characterizes example 4 of the present disclosure, wherein example 4 also includes the subject matter according to any one of examples 2-3, above.

The electrically-conductive traces of the heating tracks are uniformly spaced apart from each other. The PTC elements are sized such that the PTC elements underlay between 1% and 3% of the outer cover. The preceding subject matter of this paragraph characterizes example 5 of the present disclosure, wherein example 5 also includes the subject matter according to any one of examples 2-4, above.

The antenna heater further comprises a first clamp arm and a second clamp arm, coupleable to the first clamp arm such that, when coupled, the first clamp arm and the second clamp arm surround a majority of an outer periphery of the heating panel. The preceding subject matter of this paragraph characterizes example 6 of the present disclosure, wherein example 6 also includes the subject matter according to any one of examples 2-5, above.

The heating panel is fixed to the first clamp arm such that the heating panel and the first clamp arm do not move relative to each other. The preceding subject matter of this paragraph characterizes example 7 of the present disclosure, wherein example 7 also includes the subject matter according to example 6, above.

First end portions of the first clamp arm and the second clamp arm are pivotally coupled to each other such that the second clamp arm is pivotable relative to the first clamp arm at the first end portions of the first clamp arm and the second clamp arm. The first clamp arm comprises a first-clamp-arm lock portion at a second end portion of the first clamp arm. The second clamp arm comprises a second-clamp-arm lock portion at a second end portion of the second clamp arm. The first-clamp-arm lock portion and the second-clamp-arm lock portion are engageable to selectively lock together the second end portions of the first clamp arm and the second clamp arm. The preceding subject matter of this paragraph characterizes example 8 of the present disclosure, wherein example 8 also includes the subject matter according to example 7, above.

Each one of the first clamp arm and the second clamp arm defines a U-shaped channel that has a width at least twice a thickness of the heating panel. The preceding subject matter of this paragraph characterizes example 9 of the present disclosure, wherein example 9 also includes the subject matter according to any one of examples 6-8 above.

The PTC elements of each one of the heating tracks are mounted directly to the electrically-conductive trace of the heating track. The preceding subject matter of this paragraph characterizes example 10 of the present disclosure, wherein example 10 also includes the subject matter according to any one of examples 1-9 above.

The electrically-conductive traces of the heating tracks are electrically connected together in parallel. The preceding subject matter of this paragraph characterizes example 11 of the present disclosure, wherein example 11 also includes the subject matter according to any one of examples 1-10 above.

A distance between adjacent ones of the PTC elements 130 is such that signal attenuation, caused by the antenna heater is between 0 dB and 2 dB when the antenna is operated without foreign material on the antenna. The preceding subject matter of this paragraph characterizes example 12 of the present disclosure, wherein example 12 also includes the subject matter according to any one of examples 1-11 above.

Further disclosed herein is an antenna heater system. The antenna heater system comprises an antenna heater, comprising a heating panel, configured for attachment to an antenna and comprising heating tracks, wherein the heating tracks are spaced apart from each other and each comprises an electrically-conductive trace and positive temperature coefficient (PTC) elements. The PTC elements are electrically connected to the electrically-conductive trace, spaced apart along the electrically-conductive trace, and made of a PTC material having an equilibrium temperature greater than 0° C. The antenna heater system also comprises a temperature sensor, configured to detect temperature of air external to the antenna heater. The antenna heater system further comprises a humidity sensor, configured to detect relative humidity of air external to the antenna heater. The antenna heater system additionally comprises a control module, configured to supply electrical power to the electrically-conductive traces of the heating tracks, such that the PTC elements of the heating tracks generate heat, only when the temperature of the air detected by the temperature sensor is below a temperature threshold and the relative humidity of the air detected by the humidity sensor is above a humidity threshold. The preceding subject matter of this paragraph characterizes example 13 of the present disclosure.

The temperature threshold is between 1° C. and 10° C., inclusive, and the humidity threshold is between 50% and 100%, inclusive. The preceding subject matter of this paragraph characterizes example 14 of the present disclosure, wherein example 14 also includes the subject matter according to example 13, above.

The equilibrium temperature of the PTC material of each one of the PTC elements is greater than 10° C. and less than 35° C. The preceding subject matter of this paragraph characterizes example 15 of the present disclosure, wherein example 15 also includes the subject matter according to example 14, above.

The control module is further configured to continuously increase a current of the electrical power from zero to a maximum current over a predetermined time interval in response to the temperature of the air detected by the temperature sensor being below the temperature threshold and the relative humidity of the air detected by the humidity sensor being above the humidity threshold. The preceding subject matter of this paragraph characterizes example 16 of the present disclosure, wherein example 16 also includes the subject matter according to any one of examples 13-15, above.

Additionally disclosed herein is a method of preventing ice formation on an antenna. The method comprising a step of activating an antenna heater, mounted to the antenna, to supply heat to the antenna only when air, around the antenna, has a temperature below a temperature threshold and has a relative humidity above a humidity threshold. Activating the antenna heater comprises heating positive temperature coefficient (PTC) elements of the antenna heater up to an equilibrium temperature of PTC material of the PTC elements. The preceding subject matter of this paragraph characterizes example 17 of the present disclosure.

The antenna is a drum antenna comprising a hollow base, defining a signal transmission opening through which electromagnetic waves are transmitted from the drum antenna and received by the drum antenna, and an external cover that covers the signal transmission opening and encloses the hollow base. The method further comprises a step of mounting a heating panel of the antenna heater onto the hollow base such that the heating panel covers the external cover. The preceding subject matter of this paragraph characterizes example 18 of the present disclosure, wherein example 18 also includes the subject matter according to example 17, above.

The step of mounting the heating panel of the antenna heater onto the hollow base comprises receiving a first portion of an outer ledge of the antenna into a first-clamp-arm channel of a first clamp arm of the antenna heater, receiving a second portion of the outer ledge of the hollow base into a second-clamp-arm channel of a second clamp arm of the antenna heater, and when the first portion of the outer ledge is received into the first-clamp-arm channel and the second portion of the outer ledge is received into the second-clamp-arm channel, locking together the first clamp arm and the second clamp arm. The preceding subject matter of this paragraph characterizes example 19 of the present disclosure, wherein example 19 also includes the subject matter according to example 18, above.

The heating panel is fixed to the first clamp arm, such that the heating panel does not move relative to the first clamp arm and such that the heating panel is moved into position over the external cover of the antenna as the first portion of the outer ledge is received into the first-clamp-arm channel. The preceding subject matter of this paragraph characterizes example 20 of the present disclosure, wherein example 20 also includes the subject matter according to example 19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended numbered paragraphs, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a perspective, schematic view of an antenna tower having multiple antennas, according to one or more examples of the present disclosure;

FIG. 2 is a perspective, schematic view of an antenna, according to one or more examples of the present disclosure;

FIG. 3 is a perspective, schematic view of an antenna assembly, according to one or more examples of the present disclosure;

FIG. 4 is a perspective, schematic view of an antenna assembly, according to one or more examples of the present disclosure;

FIG. 5 is a perspective, sectional, schematic view of the antenna assembly of FIG. 4, taken along line 5-5 of FIG. 4, according to one or more examples of the present disclosure;

FIG. 6 is a perspective, sectional, schematic view of a portion of an antenna assembly, according to one or more examples of the present disclosure;

FIG. 7 is a perspective, partially sectioned, schematic view of an antenna heater, according to one or more examples of the present disclosure;

FIG. 8 is a plan, schematic view of a cover and heating tracks of an antenna heater, according to one or more examples of the present disclosure;

FIG. 9 is a perspective, schematic view of a cover and heating tracks of an antenna heater, according to one or more examples of the present disclosure;

FIG. 10 is a perspective, schematic view of an antenna heater being installed onto an antenna, according to one or more examples of the present disclosure;

FIG. 11 is a perspective, schematic view of the antenna heater of FIG. 10 partially installed on the antenna, according to one or more examples of the present disclosure;

FIG. 12 is a perspective, schematic view of the antenna heater of FIG. 10 fully installed on the antenna, according to one or more examples of the present disclosure;

FIG. 13 is a block diagram of an antenna system, according to one or more examples of the present disclosure;

FIG. 14 is a schematic flow chart of a method of preventing ice formation on an antenna, according to one or more examples of the present disclosure; and

FIGS. 15A-15C are graphs illustrating current-voltage, resistance-temperature, and power-voltage characteristics, respectively, for a positive temperature coefficient (PTC) material, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

The subject matter of the present disclosure includes examples of an antenna system and corresponding antenna heater that actively and intelligently prevents the accumulation of snow, the formation of ice, or both on an antenna of the antenna system in a safe, efficient, and environmentally sensitive manner. In certain examples, the antenna heater utilizes positive temperature coefficient (PTC) materials that self-regulate the heat generated by the antenna heater without the need for complex control systems, which promotes reliability, longevity, and a reduction in operational and servicing costs. According to some examples, the antenna heater enables safe and easy retrofitting of an antenna in the field by a single service engineer with zero or minimal changes to the existing software or hardware of the antenna. Additionally, the antenna heater may have a limited and/or negligible effect, if any, on the attenuation of signals transmitted from or received by the antenna to which the antenna heater is coupled.

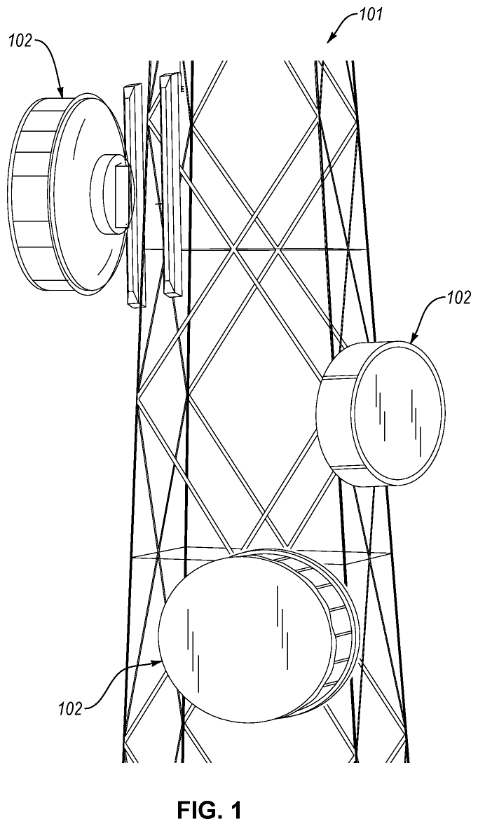

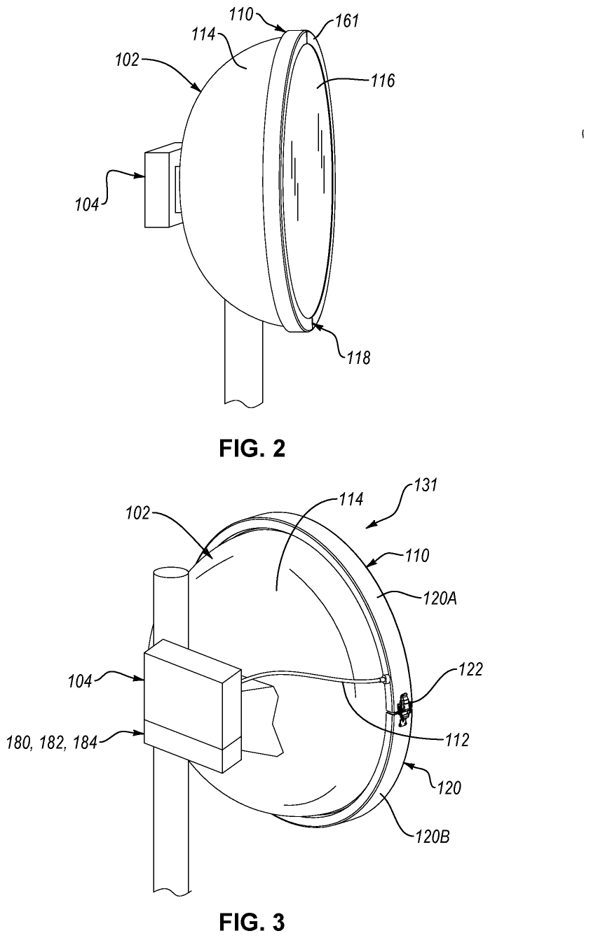

FIG. 1 illustrates an example of an antenna tower 101. The antenna tower 101 has multiple antennas 102. The antennas 102 of FIG. 1 are depicted as drum antennas, but could be other types of antennas known in the art. Generally, as shown in FIG. 2, according to one example, the antenna 102, as used in the illustrative examples disclosed herein, is a drum antenna that includes a hollow base 114 and an external cover 116 fixed to the hollow base 114. Although the description herein makes reference to a drum antenna, the description can be applied to other types of antennas, such as antennas with different shapes or different structures. For example, in addition to a circular-shaped drum antenna, the description can be applied to drum antenna having non-circular outer peripheral shapes, such as rectangular or square. Additionally, although the external cover 116 of the drum antenna shown in the illustrated examples is flat or planar, in some examples, the description can be applied to an external cover of a drum antenna or other type of antenna that has a non-planar or contoured external cover.

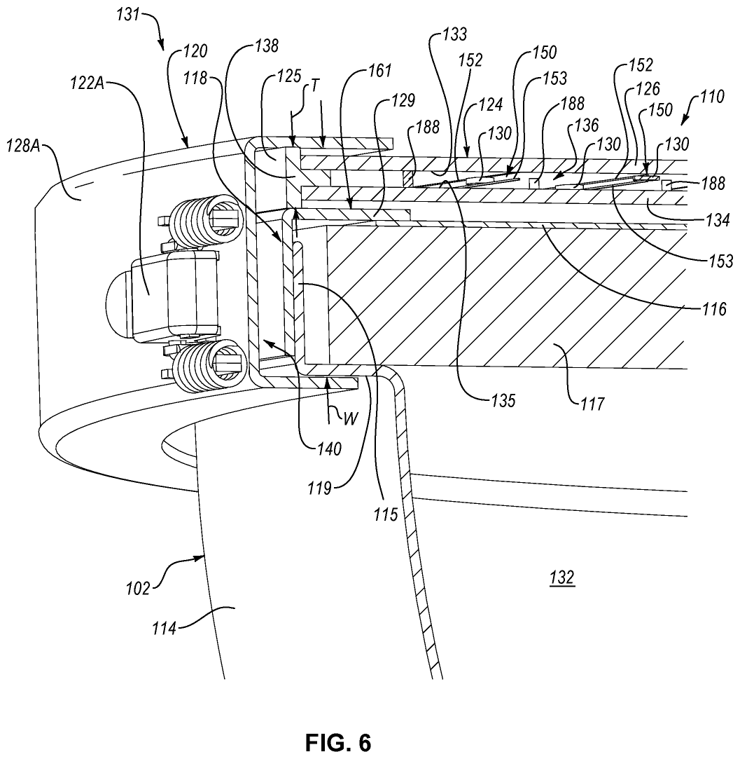

In the example of FIG. 2, the hollow base 114 is cone or dome shaped and converges in a directly away from the external cover 116. However, in other examples, such as some of the antennas 102 shown in FIG. 1, the hollow base 114 is cylindrical shaped. The hollow base 114 includes a signal transmission opening 115 through which electromagnetic waves (e.g., signals) are transmitted from the antenna 102 and received by the antenna 102 (see, e.g., FIGS. 5 and 6). Although not shown, the antenna 102 includes a signal transmitter, a signal receiver, or a signal transceiver. The signal transmitter generates and transmits electromagnetic waves, which enables the antenna 102 to operate as a data uplink. The signal receiver receives electromagnetic waves generated by other transmitters (e.g., other antenna), which enables the antenna 102 to operate as a data downlink. The signal transceiver generates and receives electromagnetic waves, which enables the antenna 102 to operate as both a data uplink and data downlink. Power for transmitting and/or receiving electromagnetic waves is provided by a power supply 104.

The external cover 116 overlays the signal transmission opening 115 and encloses the hollow base 114. An interior cavity 132 of the antenna 102 is thus defined between the hollow base 114 and the external cover 116. The external cover 116 helps prevent debris from entering the interior cavity 132 and disrupting signal transmission and/or signal reception, such as by attenuating signals sent or received by the antenna 102. In some examples, such as shown, the external cover 116 is flat. Moreover, the external cover 116 has an outer peripheral shape that corresponds with (e.g., matches) that of the hollow base 114. For example, the external cover 116 can be disk shaped and have an outer peripheral shape that is circular. The external cover 116 is made of a material that provides sufficient protection from debris, while having limited effects, if any, on the attenuation of the electromagnetic waves passing through the external cover 116. In some examples, the external cover 116 is made of a hardened plastic material, such as a fiber-reinforced polymer (e.g., fiberglass).

Referring to FIGS. 5 and 6, in some examples, the antenna 102 further comprises a backing layer 117 that is coupled to and supports the external cover 116. The backing layer 117 promotes rigidity of the external cover 116. Additionally, in certain examples, the backing layer 117 is made of a thermally insulating material, such as a hardened foam, that helps insulate the interior cavity 132 from harsh environmental conditions. The external cover 116 can be affixed to the backing layer 117, such as via an adhesive or with fasteners.

Generally, the external cover 116 is coupled to the hollow base 114 by a ring 161 that extends circumferentially about the hollow base 114 and the external cover 116 to effectively clamp the external cover 116 to the hollow base 114. The ring 161 has a generally L-shaped cross-section and defines, along with an outer flange 119 or shelf of the hollow base 114, an outer ledge 118 of the antenna 102 (see, e.g., FIGS. 2 and 6). Because the ring 161 and outer flange of the hollow base 114 is circular, in some examples, the outer ledge 118 also is circular. In some examples, as best shown in FIG. 6, the ring 161 attaches, such as via fasteners, to the outer flange of the hollow base 114, which defines the signal transmission opening 115. When attached to the hollow base 114, a top flange 129 of the ring 161 overlays a peripheral portion of the external cover 116 to retain the external cover 116 (and, e.g., the backing layer 117) against the hollow base 114 (see, e.g., FIG. 6).

As previously presented, in some harsh environmental conditions, such as those with colder temperatures, the antenna 102 is prone to the accumulation of snow, formation of ice, or both, on the external cover 116. The accumulation of snow, the formation of ice, or both on the external cover 116 can cause a dramatic increase in the attenuation of signals transmitted from or received by the antenna 102. Referring to FIG. 3, and according to some examples, the subject matter of the present disclosure includes an antenna heater 110 that is coupled to the antenna 102 and is operable to produce heat that reduces or prevents the accumulation of snow, the formation of ice, or both, on the external cover 116 and on the antenna heater 110. In this manner, signal attenuation, due to the formation of ice on the external cover 116, can be reduced or prevented.

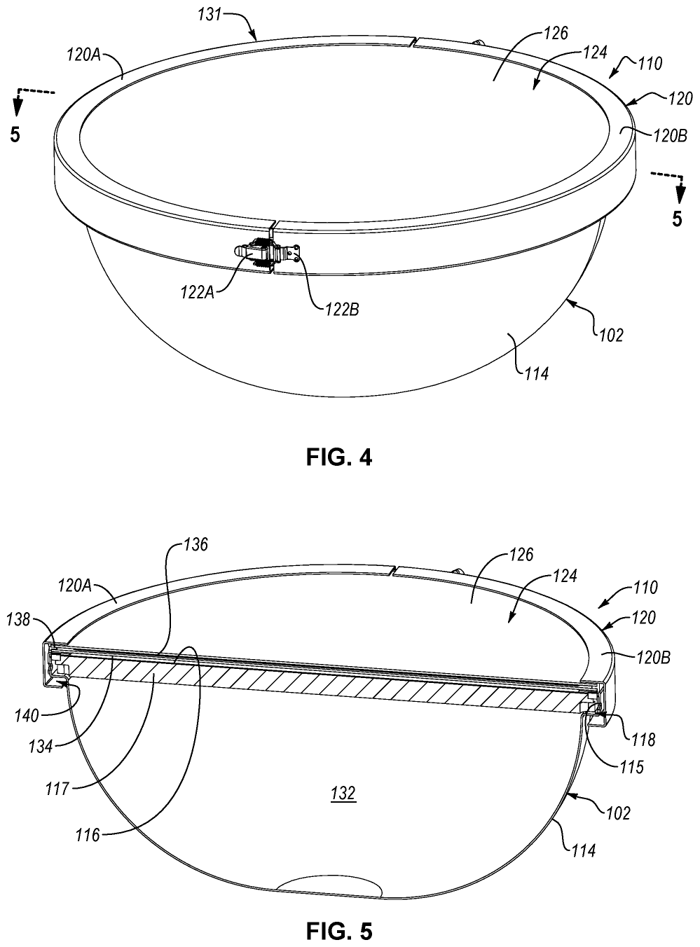

As shown in FIG. 4, the antenna heater 110 includes a heating panel 124 and a clamp assembly 120. As will be explained in more detail, the clamp assembly 120 mounts the heating panel 124 to the antenna 102 to form an antenna assembly 131, which includes the antenna 102 and the antenna heater 110. The heating panel 124 of the antenna heater 110 includes an outer cover 126 that is exposed to the environment. In some examples, the outer cover 126 is flat or planar, and is parallel with the external cover 116 of the antenna 102. The heating panel 124 also includes an inner cover 134 that is spaced apart from the outer cover 126 such that a gap 136 is defined between the outer cover 126 and the inner cover 134 (see, e.g., FIG. 5). The inner cover 134 can also be flat or planar, and parallel with the outer cover 126, such that the heating panel 124 has a multi-layer sandwich configuration. The outer cover 126 and the inner cover 134 can be made of a strong and durable material. Moreover, the outer cover 126 and the inner cover 134 are made of a material that does not substantially negatively affect the attenuation of electromagnetic signals passing through the material. In some examples, the outer cover 126 and the inner cover 134 are made of a polymer, such as a fiber-reinforced polymer (e.g., fiberglass), polyvinyl chloride (PVC), nylon, and/or acrylonitrile butadiene styrene (ABS). In some examples, the outer cover 126 and the inner cover 134 are made of the same material. However, in other examples, the outer cover 126 and the inner cover 134 are made of different materials.

As shown in FIGS. 5 and 6, the heating panel 124 further includes a gasket 138 positioned between, and extending circumferentially about, an outer perimeter of the outer cover 126 and the inner cover 134. The gasket 138 seals the gap 136 between the outer cover 126 and the inner cover 134 to prevent contaminants, such as moisture, from entering the gap 136. Additionally, the gasket 138, extending circumferentially about the outer cover 126 and the inner cover 134, thus having an annular or circular shape, defines an outer periphery 125 of the heating panel 124 and helps maintain a gap 136 between the outer cover 126 and the inner cover 134 (see, e.g., FIG. 6). The gasket 138 is made of a compliant material, such as EPDM rubber, in some examples. To promote rigidity and mechanical reinforcement of the heating panel 124, in some examples, the heating panel 124 includes spacers 188 within the gap 136 and extending from the outer cover 126 to the inner cover 134. The spacers 188 are spaced apart from each other and provide a load-bearing support that transfers loads between the outer cover 126 and the inner cover 134 to help strengthen the heating panel 124 and maintain the gap 136 between the outer cover 126 and the inner cover 134.

In the illustrated examples, the heating panel 124 has an outer peripheral shape corresponding with an outer peripheral shape of the antenna 102. For example, the outer cover 126 and the inner cover 134 can be disk-shaped and thus have an outer peripheral shape that is circular. However, in other examples, the outer peripheral shape of the heating panel 124 can be non-circular, such as to correspond with an antenna having a non-circular shape.

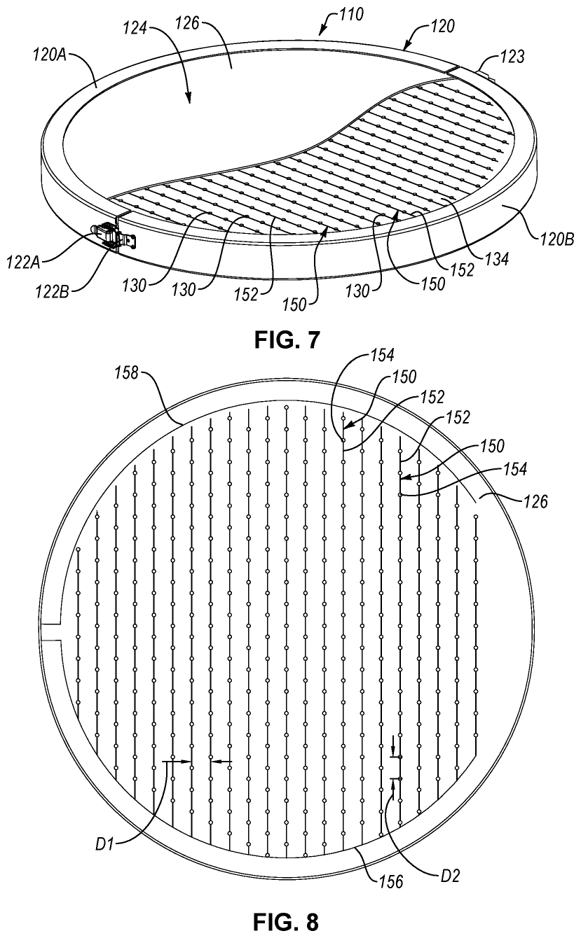

Referring to FIGS. 6-9, the heating panel 124 additionally includes heating tracks 150 located in the gap 136. Each one of the heating tracks 150 includes an electrically-conductive trace 152 and positive temperature coefficient (PTC) elements 130. The PTC elements 130 of a heating track 150 are electrically connected to the electrically-conductive trace 152 of the heating track 150. The heating tracks 150 are spaced apart from each other, for example, by a distance D1. Additionally, the PTC elements 130 of each one of the heating tracks 150 are spaced apart from each other along the electrically-conductive trace 162 of the corresponding heating track 150, for example, by a distance D2. In some examples, the PTC elements 130 are mounted directly to the electrically-conductive traces 152 of the heating tracks 150. In some examples, the PTC elements 130 are soldered to or adhered (such as via an electrically conductive glue or paste) to the electrically-conductive traces 152. Also, in certain examples, the spacers 188 are spaced apart from, or do not overlap with, the PTC elements 130.

The heating tracks 150 are affixed to an internally-facing surface 133 of the outer cover 126 or an externally-facing surface 135 of the inner cover 134 (see, e.g., FIG. 6). As used herein, the term “internally-facing” means facing towards the interior cavity 132 of the antenna 102, and the term “externally-facing” means facing away from the interior cavity 132 of the antenna 102, when the antenna heater 110 is mounted to the antenna 102. In the examples shown in FIGS. 6-9, the heating tracks 150 are affixed to the internally-facing surface 133 of the outer cover 126. In such examples, the electrically-conductive traces 152 are affixed onto the internally-facing surface 133 of the outer cover 126 and the PTC elements 130 are mounted onto the electrically-conductive traces 152, such that for each one of the heating tracks 150, the electrically-conductive trace 152 is interposed between the PTC elements 130 and the internally-facing surface 133 of the outer cover 126. However, in other examples, the PTC elements 130 can be affixed to the internally-facing surface 133 of the outer cover 126 and the electrically-conductive traces 152 are applied onto the PTC elements 130, such that for each one of the heating tracks 150, the PTC elements 130 are interposed between the electrically-conductive trace 152 and the internally-facing surface 133 of the outer cover 126.

In other examples, the heating tracks 150 are positioned on the inner cover 134. In some examples, the electrically-conductive traces 152 are affixed onto the externally-facing surface 135 of the inner cover 134 and the PTC elements 130 are mounted onto the electrically-conductive traces 152, such that for each one of the heating tracks 150, the electrically-conductive trace 152 is interposed between the PTC elements 130 and the externally-facing surface 135 of the inner cover 134. However, in other examples, the PTC elements 130 can be affixed to the externally-facing surface 135 of the inner cover 134 and the electrically-conductive traces 152 are applied onto the PTC elements 130, such that for each one of the heating tracks 150, the PTC elements 130 are interposed between the electrically-conductive trace 152 and the externally-facing surface 135 of the inner cover 134.

In some examples, when the heating tracks 150 are affixed to the internally-facing surface 133 of the outer cover 126, the gap 136 of the heating panel 124 provides a thermal barrier that helps direct heat generated by the PTC elements 130 toward and into the outer cover 126. However, in certain examples, the gap 136 is small enough that either the electrically-conductive traces 152, the PTC elements 130, or both are in contact with both the internally-facing surface 133 of the outer cover 126 and the externally-facing surface 135 of the inner cover 134.

In some embodiments, the heating panel 124 includes more than two covers (i.e., more than the inner cover 134 and the outer cover 126) while in other embodiments the heating panel 124 may include a single cover and the heating tracks 150 are coupled to the single cover (e.g., the inner surface of the single cover). In some examples, the heating tracks 150 are applied to an internal or external surface of the external cover 116 of the antenna 102, such that an additional cover is not required. In other examples, a single cover including the heating tracks 150 is applied to the external cover 116 (e.g., the single cover may be adhered to the inner or outer surface of the external cover 116).

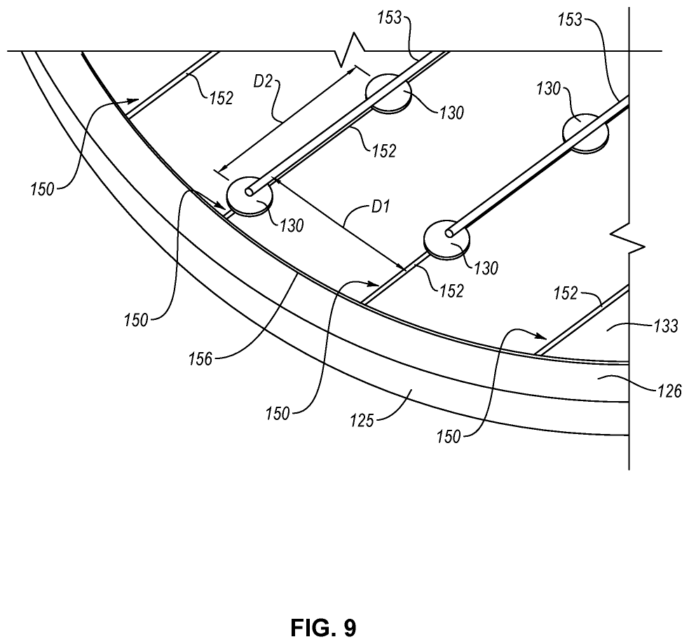

Referring to FIG. 8, the electrically-conductive traces 152 of the heating tracks 150 are electrically connected together in parallel. More specifically, corresponding first ends of the electrically-conductive traces 152 are independently electrically connected to the same electrical input line 156. The electrically-conductive traces 152 are made of copper in some examples. The PTC elements 130 of a given heating track 150 are also connected in parallel via the electrically-conductive trace 152 of the given heating track 150 and a wire 153 of the given heating track 150 (see, FIG. 9). It is noted that the wires 153 are not shown in FIG. 8 for convenience. Referring to FIG. 9, the wire 153 of a given heating track 150 is electrically connected (e.g., soldered) to each one of the PTC elements 130 of the given heating track 150. Moreover, the ends of the wires 153 of the heating tracks 150 are independently electrically connected to the same electrical output line 158. In this manner, the electrically-conductive traces 152 are electrically connected directly to the electrical input line 156, but not electrically connected directly to the electrical output line 158, and the wires 153 are electrically connected directly to the electrical output line 158, but not electrically connected directly to the electrical input line 156. Accordingly, positive current flows to the PTC elements 130, from the electrical input line 156, via the electrically-conductive traces 152 and negative current flows from the PTC elements 130, to the electrical output line 158, via the wires 153.

The characteristics of the PTC element 130 described below is applicable to all the PTC elements 130 of the antenna heater 110. The PTC element 130 can have any of various shapes and sizes. In some examples, the PTC element 130 is disk-shaped and has a circular-shaped outer periphery and a height or thickness. In other examples, the PTC element 130 has a non-circular-shaped outer periphery, such as having a rectangular, lozenge, trapezoid, triangular, or other shape, and/or non-planar top and bottom surfaces (e.g., forming a round or oval shape). Additionally, in certain examples, the PTC element 130 is small, such that the PTC elements 130 of one heating track 150 are spaced apart, along the outer cover 126, from all PTC elements 130 of an adjacent one of the heating tracks 150. In one example, the PTC element 130 has a maximum dimension (e.g., diameter) between 2 millimeters (mm) and 30 mm, such as 3 mm. Moreover, the PTC element 130 is thin relative to the maximum dimension. For example, the thickness of the PTC element 130 is no greater than 30% of the maximum dimension of the PTC element 130. The surface of each PTC element 130 facing and affixed to the internally-facing surface 133 of the outer cover 126 has a PTC-element surface area and the internally-facing surface 133 of the outer cover 126 has an outer-cover surface area. In some examples, the PTC-element surface area is about 20 mm² and the outer-cover surface area is about 342,119 mm². The PTC-element surface area, the quantity of PTC elements 130, and the outer-cover surface area are selected such that the PTC elements 130 underlay a desired percentage of the outer cover 126. The desired percentage corresponds with a desired minimum signal attenuation caused by the PTC elements 130. In some examples, the percentage of the outer cover 126 underlaid by the PTC elements 130 is between 0.1% and 10.0%, between 0.5% and 5.0%, or between 1.0% and 3.0%. As used herein, the percentage of the outer cover 126 underlaid by the PTC elements 130 corresponds with a ratio of a combined PTC-element surface area (which is equal to a summation of the PTC-element surface area of all the PTC elements 130) to the outer-cover surface area of the internally-facing surface 133.

In some examples, the maximum dimension of the PTC element 130 is more than a width of the electrically-conductive trace 152. However, in other examples, the maximum dimension of the PTC element 130 is less than or equal to the width of the electrically-conductive trace 152. According to some examples, each one of the electrically-conductive traces 152 has a width of about 4 mm and a thickness of about 100 microns.

Each one of the PTC elements 130 is made of a PTC material. In some examples, the PTC material is made of poly-crystalline ceramic materials, such as barium carbonate and titanium oxide, that are highly electrically resistive in an original state, but are made semi-conductive by the addition of dopants, such as tantalum, silica, and manganese. Accordingly, the PTC material of the PTC element 130 can include a combination of poly-crystalline ceramic materials and conductive dopants. In other examples, the PTC material is made of an electrically non-conductive plastic material with embedded conductive grains, such as carbon grains.

Generally, the PTC material of the PTC element 130 self-regulates or self-limits the temperature of the PTC element 130, and thus the antenna heater 110, by increasing the electrical resistance of the PTC material as the temperature of the PTC material increases. As the temperature approaches an equilibrium temperature, which can be defined as a maximum, transition, or Curie temperature of the PTC material, the electrical resistance of the PTC material “switches” to rapidly increases toward infinite resistance. In some implementations, the equilibrium temperature is defined as the temperature at which the electrical resistance of the PTC material is about twice the resistance as a minimum electrical resistance of the PTC material. The rapid increase in the electrical resistance at the equilibrium temperature rapidly reduces the electrical current allowed to flow through the PTC material. With less current flowing through the PTC material, the temperature of the PTC material correspondingly drops below the equilibrium temperature, which results in a corresponding drop in the electrical resistance of the PTC material and an increase in the current allowed through the PTC material. The increase in current contributes to an increase in the temperature of the PTC material until the equilibrium temperature is again established and the cycle of rapidly increasing the electrical resistance, rapidly decreasing the current, and decreasing the temperature of the PTC material is continued.

In the above manner, with the supply of electrical power from an electrical power supply (such as from the power supply 104 via a power cable 112 of the antenna heater 110 (see, e.g., FIG. 3)) at a constant (e.g., unchanging) voltage above an equilibrium voltage, the unique properties of the PTC material allow the PTC material to self-limit its temperature to increase up to but not exceed an equilibrium temperature. Furthermore, because the PTC material self-regulates its temperature, extraneous components and systems for regulating the temperature of antenna heater 110 are not necessary. Although the material of the PTC element 130 has been described as being a PTC material, in some examples, the material of the PTC element 130 be any of various other electrically-conductive materials.

According to certain examples, the PTC material of the PTC element 130 has an equilibrium temperature greater than 0° C. Such an equilibrium temperature will ensure that environmental temperatures at or below freezing, the temperature of the PTC elements 130 will remain above freezing. For example, in some implementations, the equilibrium temperature of the PTC element 130 is greater than 10° C. and less than 35° C., such as 19° C.

The antenna heater 110 includes multiple heating tracks 150 each including multiple PTC elements 130. In some examples, the antenna heater 110 includes at least ten heating tracks 150 and between one hundred and three hundred PTC elements 130. According to one example, the antenna heater 110 includes at least twenty heating tracks 150. Referring to FIG. 8, the electrically-conductive traces 152 of the heating tracks 150 are spaced apart from adjacent ones of the electrically-conductive traces 152 by a first distance D1. Moreover, the PTC elements 130 of a heating track 150 are spaced apart from adjacent ones of the PTC elements 130 along the electrically-conductive trace 152 of the heating track 150 by a second distance D2. Generally, the first distance D1 and the second distance D2 is selected to promote both heating functionality and minimal signal attenuation (e.g., around 1 dB of signal attenuation). In some examples, the first distance D1 is at least 30 mm (e.g., at least 60 mm) and the second distance D2 is at least 30 mm.

The first distance D1 is the same as the second distance D2 in some examples, to facilitate a uniform heat distribution of heat generated by the antenna heater 110 in uniform across the heating panel 124. However, in other examples, the first distance D1 can be smaller than or greater than the second distance D2. Additionally, to promote uniform heating, in some examples, for each heating track 150, the first distance D1 between adjacent ones of the electrically-conductive traces 152 is the same and/or the second distance D2 between adjacent ones of the PTC elements 130 is the same. But, in other examples, the first distance D1 and/or the second distance D2 can vary such that the distribution of heat generated by the antenna heater 110 is non-uniform across the heating panel 124 if desired.

Referring again to FIG. 3, the clamp assembly 120 of the antenna heater 110 includes a first clamp arm 120A and a second clamp arm 120B. The first clamp arm 120A and the second clamp arm 120B are selectively coupled together to surround a majority of the outer periphery 125 of the heating panel 124. Moreover, when coupled together, the first clamp arm 120A and the second clamp arm 120B effectively clamp onto the antenna 102 about the outer ledge 118 of the antenna 102. Accordingly, the first clamp arm 120A and the second clamp arm 120B, when clamped onto the antenna 102, surround a majority of the outer ledge 118 of the antenna 102. The first clamp arm 120A and the second clamp arm 120B are selectively coupled together via a locking mechanism 122 as will be further explained below.

The clamp assembly 120 is configured to clamp onto the antenna 102 and clamp the heating panel 124 to the antenna 102. In other words, the clamp assembly 120 is configured to simultaneously selectively clamp the heating panel 124 to the antenna 102 as the clamp assembly 120 is clamped to the antenna 102. Clamping of the clamp assembly 120 onto the antenna 102 is facilitated by engagement between the first clamp arm 120A and the second clamp arm 120B with the outer ledge 118 of the antenna 102. Accordingly, the first clamp arm 120A and the second clamp arm 120B are configured to receive and retain the outer ledge 118 of the antenna 102. Referring to FIGS. 5 and 6, the first clamp arm 120A and the second clamp arm 120B define channels sized and shaped to receive and retain corresponding portions of the outer ledge 118. In the illustrated examples, the outer ledge 118 has a substantially U-shaped outer surface. Accordingly, each one of the first clamp arm 120A and the second clamp arm 120B has a U-shaped channel 140 that receives a portion of the outer ledge 118 such that the first clamp arm 120A and the second clamp arm 120B effectively wrap around or surround the outer ledge 118 when coupled together. When the outer ledge 118 in annular shaped, the first clamp arm 120A and the second clamp arm 120B each has a semi-circular shape. In this manner, the first clamp arm 120A and the second clamp arm 120B are effectively two equal halves of an annular-shaped clamp.

Referring to FIG. 6, the U-shaped channel 140 has a width W that is greater than a width of the outer ledge 118. In this manner, the U-shaped channel 140 is enabled to receive both the outer ledge 118 and the heating panel 124. In other words, the width W of the U-shaped channel 140 is at least as great as a summation of the width of the outer ledge 118 and a thickness T of the heating panel 124. Generally, the width of the outer ledge 118 is greater than the thickness T of the heating panel 124. Accordingly, in some examples, the width W of the U-shaped channel 140 is at least twice a thickness T of the heating panel 124.

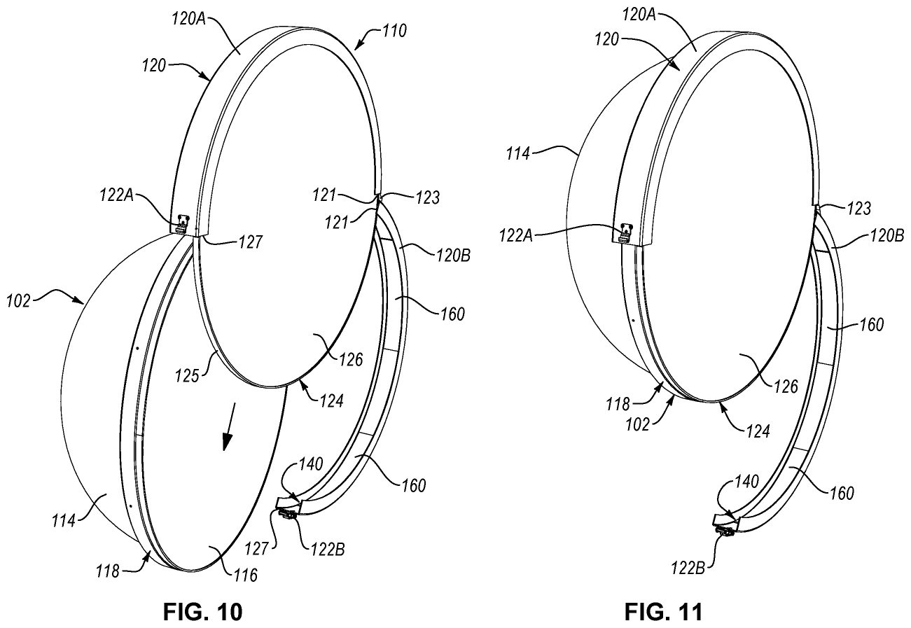

The first clamp arm 120A and the second clamp arm 120B are selectively engaged with each other to clamp onto the outer ledge 118. Therefore, the first clamp arm 120A and the second clamp arm 120B are movable relative to each other to clamp down onto the outer ledge 118. As shown in FIG. 10, each one of the first clamp arm 120A and the second clamp arm 120B includes a first end portion 121 and a second end portion 127, which is opposite the first end portion 121. Engagement between the first clamp arm 120A and the second clamp arm 120B includes intercoupling of the first end portions 121 of the first clamp arm 120A and the second clamp arm 120B and intercoupling of the second end portions 127 of the first clamp arm 120A and the second clamp arm 120B. In some examples, intercoupling at the first end portions 121 and the second end portions 127 is facilitated by respective locking mechanisms 122 located at the first end portions 121 and the second end portions 127. The locking mechanisms 122 can be the same such that the first end portions 121 and the second end portions 127 are intercoupled in the same way.

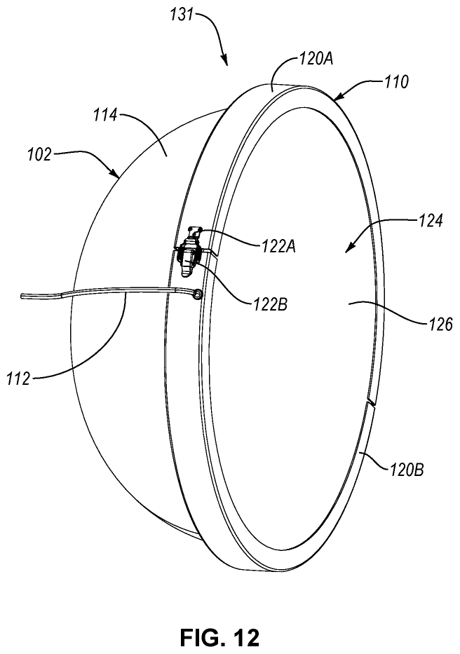

However, in other examples, the locking mechanisms 122 are different such that the first end portions 121 and the second end portions 127 are intercoupled in different ways. For example, as shown in FIG. 10, the first end portions 121 of the first clamp arm 120A and the second clamp arm 120B are intercoupled via a swivel bracket 123, which enables the first end portions 121 to swivel relative to each other while remaining coupled to each other, and the second end portions 127 of the first clamp arm 120A and the second clamp arm 120B are intercoupled via a lock (e.g., a locking clamp), which enables the second end portions 127 to be selectively locked together. Referring to FIG. 12, in some examples, the lock includes a first-clamp-arm lock portion 122A (e.g., a latch) at the second end portion 127 of the first clamp arm 120A and a second-clamp-arm lock portion 122B (e.g., a hook) at the second end portion 127 of the second clamp arm 120B. The first-clamp-arm lock portion 122A and the second-clamp-arm lock portion 122B are engageable to selectively lock together the second end portions 127 of the first clamp arm 120A and the second clamp arm 120B.

To aid in installation of the antenna heater 110 onto the antenna 102, in some examples, the heating panel 124 is fixed to the first clamp arm 120A such that the heating panel 124 does not move relative to the first clamp arm 120A. The antenna heater 110 is adhered or fastened to the first clamp arm 120A in certain examples. More specifically, the heating panel 124 can be inserted into the U-shaped channel 140 of the first clamp arm 120A and adhesively fixed or fastened in place. In this manner, the clamp assembly 120 and the heating panel 124 can be moved together as a single unit, which enables a single technician to handle and manipulate the antenna heater 110.

Referring to FIG. 11, in some examples, the clamp assembly 120 further includes padding 160 located within the U-shaped channel 140 of one or both of the first clamp arm 120A and the second clamp arm 120B. The padding 160 is compliant and deforms against the heating panel 124 as the second clamp arm 120B is moved to receive the heating panel 124 within the U-shaped channel 140 of the second clamp arm 120B. The padding 160 promotes a seal against the heating panel 124 and helps to prevent damage to the heating panel 124 as the second clamp arm 120B is moved to receive the heating panel 124.

According to some examples, the antenna heater 110 is coupled to (e.g., installed onto) the antenna 102 by moving the antenna heater 110 relative to the antenna 102 such that the first clamp arm 120A (e.g., upper clamp arm) is above the outer ledge 118 of the antenna 102 (see, e.g., FIG. 10). Then, the antenna heater 110 is lowered such that the outer ledge 118 is received into the U-shaped channel of the first clamp arm 120A and the first clamp arm 120A rests on the outer ledge 118 (see, e.g., FIG. 11). Because the antenna 102 supports the antenna heater 110 in this position, a technician need not continue to lift the antenna heater 110. The second clamp arm 120B (e.g., lower clamp arm) can then be pivoted relative to the first clamp arm 120A and raised to receive the outer ledge 118 into the U-shaped channel 140 of the second clamp arm 120B (see, e.g., FIG. 12). When the outer ledge 118 is fully received in the U-shaped channel 140 of the second clamp arm 120B, the first-clamp-arm lock portion 122A and the second-clamp-arm lock portion 122B can be engaged to lock the second clamp arm 120B to the first claim arm 120A.

Because the heating panel 124 is non-movably fixed to the first clamp arm 120A, as the first clamp arm 120A is lowered to receive the outer ledge 118, the heating panel 124 is moved over and covers the external cover 116 of the antenna 102. Accordingly, the heating panel 124 can be positioned in front of the external cover 116 and the outer ledge 118 can be inserted into the first clamp arm 120A with one motion. In some examples, the heating panel 124 is positioned flush against the external cover 116 when the outer ledge 118 is received within the U-shaped channel 140. Again, because the antenna heater 110 is movable as a single unit, and supportable on the outer ledge 118 of the antenna 102, the process of installing the antenna heater 110 on an antenna 102, whether in the field on an existing antenna or in the factory, prior to installing the antenna in the field, can be performed by a single technician in a simple, safe, and efficient manner.

In view of the foregoing, it is recognized that the heating panel 124 can be mounted to the antenna 102 in ways other than with the clamping assembly 120. For example, the heating panel 124 can be adhered to or otherwise fastened to the antenna 102, whether in the factory, prior to installing the antenna 102 in the field, or after the antenna 102 has been installed in the field. In some examples, the heating panel 124 is permanently or removably coupled to the antenna 102 in the factory as part of the original equipment of the antenna 102. In some examples, the antenna 102 does not include an external cover 116, a backing layer 117, or both an external cover 116 and a backing layer 117. In such examples, the heating panel 124 acts as the external cover 116 to protect the antenna 102 from debris and to perform the heating function described herein. In such examples, the heating panel 124 may be permanently or removably coupled to the antenna 102. In other examples, the external cover 116, the backing layer 117, or both the external cover 116 and the backing layer 117 are modified to accommodate the heating panel 124 or to account for the protection provided by the heating panel 124 (for example, the external cover 116, the backing layer 117, or both the external cover 116 and the backing layer 117 may have a reduced thickness and/or strength in view of the additional protection provided by the heating panel 124).

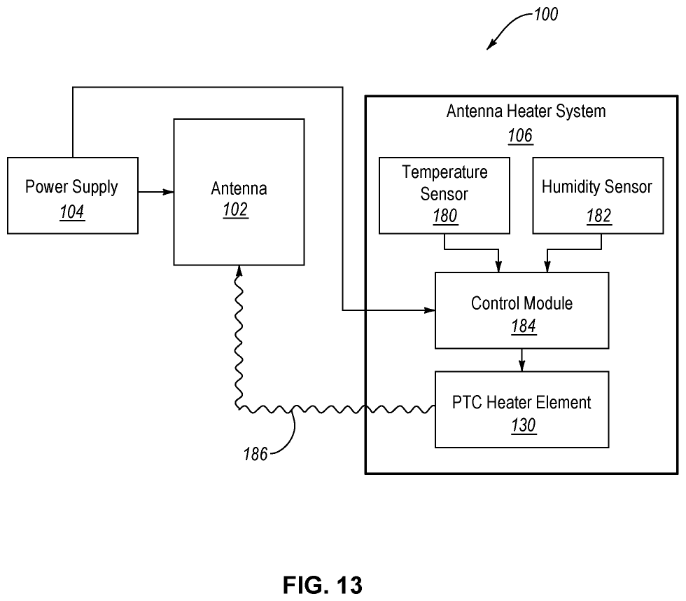

Once installed, the antenna heater 110 can be actively controlled, based on environmental conditions, to heat the antenna 102 and prevent the formation of ice on the external cover 116 of the antenna 102. Referring to FIG. 13, an antenna system 100, according to one example, is shown. The antenna system 100 includes the antenna 102, the power supply 104, and the antenna heater 110 (e.g., at least one of the PTC elements 130 of the antenna heater 110). The antenna system 100 further includes an antenna heater system 106 that includes a temperature sensor 180, a humidity sensor 182, a control module 184, and the antenna heater 110. The temperature sensor 180 is located and configured to detect the temperature of air external to the antenna heater 110, such as proximate the antenna 102. The humidity sensor 182 is located and configured to detect the humidity (e.g., relative humidity) of air external to the antenna heater 110, such as proximate the antenna 102.

The control module 184 includes computer processing capability and control to supply electrical power to the electrically-conductive traces 152 of the heating tracks 150, via the electrical input line 156. As electrical current flows through the electrically-conductive traces 152, the PTC elements 130 of the heating tracks 150 begin to increase in temperature and generate heat 186. The heat 186 generated by the PTC elements 130 is transferred to the outer cover 126 to heat the outer cover 126. The electrically-conductive trace 152 of each heating track 150, in addition to providing an electrical connection for the PTC elements 130 of the heating track 150, also help to transfer heat from the PTC elements 130 to the outer cover 126.

As electrical current continues to flow through the electrically-conductive traces 152, the temperature of and the heat generated by the PTC elements 130 continues to increase. As long as electrical current flows, the temperature and heat generated by the PTC elements 130 will continue to increase until a temperature of the PTC elements 130 reaches the equilibrium temperature of the PTC material of the PTC elements 130, at which time the PTC material of the PTC elements 130 will stabilize at an equilibrium temperature based on the power input and thermal dissipation being experienced. In this manner, the PTC elements 130 self-regulate their temperature and the amount of heat generated thereby.

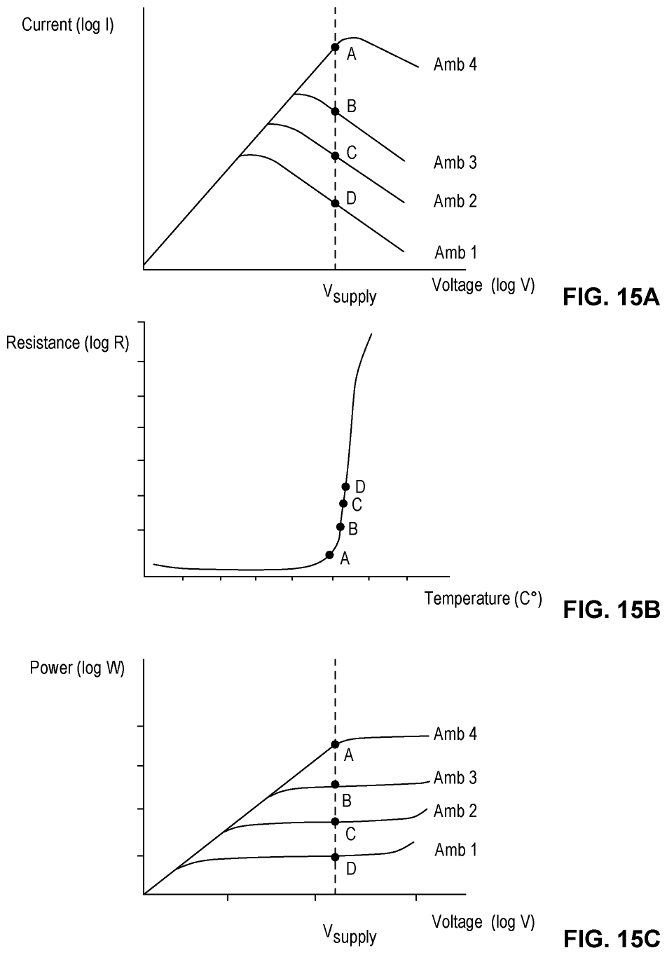

Ambient conditions have an effect on the characteristics and behavior of the PTC material of the PTC elements 130. More specifically, as shown in FIGS. 15A-15C, different ambient conditions can affect the current-voltage, the resistance-temperature, and the power-voltage characteristics of the PTC material. In this context, power is defined as heater power. Four ambient conditions, Amb1, Amb2, Amb3, and Amb4, are represented in FIGS. 15A-15C. Amb1 represents ambient conditions having a relatively high ambient temperature and static airflow. In contrast, Amb4 represents ambient conditions having a relatively low ambient temperature and a relatively high airflow. Amb2 represents ambient conditions having an ambient temperature lower than Amb1 and higher than Amb4, and airflow higher than Amb1 and lower than Amb4. Amb3 represents ambient conditions having an ambient temperature lower than Amb2 and higher than Amb4, and airflow higher than Amb2 and lower than Amb4. Points A-D are equilibrium operating points for the four ambient conditions Amb4, Amb3, Amb2, and Amb1, respectively. As shown in FIG. 15B, in most conditions, the equilibrium temperature of the PTC material is fairly constant. This is because the resistance-temperature characteristic of PTC material is very steep (e.g., up to 30%/° C. above the equilibrium temperature in certain examples). In other words, above the equilibrium temperature, a small deviation in the operating temperature of the PTC material results in a large change in the resistance of the PTC material. This phenomenon of PTC materials enables PTC materials to be very effective at self-regulation of its temperature, which is further evidenced by the relatively large differences in heater power (at a given voltage) for the different ambient conditions.

Additionally, the PTC material enables the antenna heater 110 to promote uniform heating across the antenna heater 110 despite differences in ambient condition across the ambient heater 110, such as when the surface of the antenna heater 110 experiences variable airflow. When ambient conditions across the ambient heater 110 vary, some PTC elements 130 within a localized region of the ambient heater 110 will draw more current relative to PTC elements 130 in other regions of the ambient heater 110 to promote a constant temperature across all regions of the ambient heater 110.

Moreover, as disclosed above, the PTC material of the PTC elements 130 can be selected to have an equilibrium temperature that is sufficiently high (e.g., at least 0° C.) such that snow accumulation and/or ice formation is prevented. Accordingly, the control module 184 is simply required to turn a constant supply of electrical current on and off to maintain the temperature of the PTC elements 130 at a constant temperature and the heat generated by the PTC elements 130 at a constant level.

The control module 184 turns the electrical current (e.g., electrical power) on or off based on the temperature and the humidity detected by the temperature sensor 180 and the humidity sensor 182, respectively. More specifically, the control module 184 enables the supply of electrical current to the electrically-conductive traces 152 only when the temperature of the air detected by the temperature sensor 180 is below a temperature threshold and the relative humidity of the air detected by the humidity sensor 182 is above a humidity threshold. The temperature threshold and the humidity threshold correspond with temperatures and humidity levels conducive to the formation of ice. Accordingly, when the temperature and humidity of air are not conducive to the formation of ice, which means the formation of ice on the antenna 102 is not likely, no electrical current is supplied because heat from the PTC elements 130 is not necessary to prevent the formation of ice. However, when the temperature and humidity of air are conducive to the formation of ice, the control module 184 supplies electrical current to generate heat from the PTC elements 130 and prevent the formation of ice. In certain examples, the temperature threshold is between 1° C. and 10° C., such as 7° C., and the humidity threshold is between 50% and 100%, such as 55%.

According to some examples, the control module 184 is further configured to continuously increase a current of the electrical power from zero to a maximum current over a predetermined time interval in response to the temperature of the air detected by the temperature sensor 180 being below the temperature threshold and the relative humidity of the air detected by the humidity sensor 182 being above the humidity threshold. In certain examples, the antenna heater 110 relies on the electrical power supplied to the antenna 102 for supplying the electrical current to the electrically-conductive traces 162 of the antenna heater 110. Such power is supplied at a constant voltage, such as 48 V. Ramping up the electrical current helps prevent an inrush of current, which may occur with such a constant voltage and such a high number of electrically resistive elements (e.g., the PTC elements 130) in the circuit and which can damage the electrical components of the antenna heater 110.

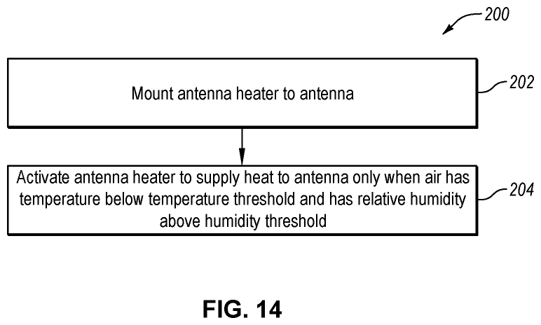

Referring to FIG. 14, according to some examples, a method 200 of preventing ice formation on the antenna 102 includes (block 202) mounting the antenna heater 110 to the antenna 102. The method 200 also includes (block 204) activating the antenna heater 110 to supply heat to the antenna 102 only when air, around the antenna 102, has a temperature below a temperature threshold and has a relative humidity above a humidity threshold. Mounting the antenna heater 110 to the antenna 102 can include clamping the heating panel 124 onto the hollow base 114 such that the heating panel 124 covers the external cover 116. Clamping the heating panel 124 onto the hollow base 114 can include receiving a first portion of the outer ledge 118 of the antenna 102 into the U-shaped channel 140 (i.e., first-clamp-arm channel) of the first clamp arm 120A, receiving a second portion of the outer ledge 118 of the antenna 102 into the U-shaped channel 140 (i.e., second-clamp-arm channel) of the second clamp arm 120B, and, when the first portion of the outer ledge 118 is received into the first-clamp-arm channel and the second portion of the outer ledge 118 is received into the second-clamp-arm channel, locking together the first clamp arm 120A and the second clamp arm 120B. In one example, the heating panel 124 is moved into position over the external cover 116 of the antenna 102 as the first portion of the outer ledge 118 is received into the first-clamp-arm channel. Activating the antenna heater 110 can include heating the PTC elements 130 of the antenna heater 110 up to the equilibrium temperature of the PTC material of the PTC elements 130.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. Examples of the scope of the present subject matter can be found in the following claims.

What is claimed is:

1. An antenna heater for heating an antenna, comprising:
a heating panel, configured for attachment to the antenna and comprising heating tracks, wherein the heating tracks are spaced apart from each other and each comprises an electrically-conductive trace and positive temperature coefficient (PTC) elements, and wherein the PTC elements are electrically connected to the electrically-conductive trace, spaced apart along the electrically-conductive trace, and made of a PTC material having an equilibrium temperature greater than 0° C.

2. The antenna heater according to claim 1, wherein:
the heating panel further comprises an outer cover and an inner cover that is spaced apart from the outer cover such that a gap is defined between the outer cover and the inner cover; and
the heating tracks are fixed to one of the outer cover or the inner cover, and are located within the gap.

3. The antenna heater according to claim 2, further comprising a gasket between the outer cover and the inner cover, wherein the gasket seals the gap and defines the outer periphery of the heating panel.

4. The antenna heater according to claim 2, wherein:
the outer cover and the inner cover are disk-shaped;
a shape of the outer periphery of the heating panel is circular;
a shape of the first clamp arm is a semi-circle; and
a shape of the second clamp arm is a semi-circle.

5. The antenna heater according to claim 2, wherein:
the electrically-conductive traces of the heating tracks are uniformly spaced apart from each other; and
the PTC elements are sized such that the PTC elements underlay between 1% and 3% of the outer cover.

6. The antenna heater according to claim 1, further comprising:
a first clamp arm; and
a second clamp arm, coupleable to the first clamp arm such that, when coupled, the first clamp arm and the second clamp arm surround a majority of an outer periphery of the heating panel.

7. The antenna heater according to claim 6, wherein the heating panel is fixed to the first clamp arm such that the heating panel and the first clamp arm do not move relative to each other.

8. The antenna heater according to claim 7, wherein:
first end portions of the first clamp arm and the second clamp arm are pivotally coupled to each other such that the second clamp arm is pivotable relative to the first clamp arm at the first end portions of the first clamp arm and the second clamp arm;
the first clamp arm comprises a first-clamp-arm lock portion at a second end portion of the first clamp arm;
the second clamp arm comprises a second-clamp-arm lock portion at a second end portion of the second clamp arm; and
the first-clamp-arm lock portion and the second-clamp-arm lock portion are engageable to selectively lock together the second end portions of the first clamp arm and the second clamp arm.

9. The antenna heater according to claim 6, wherein each one of the first clamp arm and the second clamp arm defines a U-shaped channel that has a width at least twice a thickness of the heating panel.

10. The antenna heater according to claim 1, wherein the PTC elements of each one of the heating tracks are mounted directly to the electrically-conductive trace of the heating track.

11. The antenna heater according to claim 1, wherein the electrically-conductive traces of the heating tracks are electrically connected together in parallel.

12. The antenna heater according to claim 1, wherein a distance between adjacent ones of the PTC elements 130 is such that signal attenuation, caused by the antenna heater is between 0 dB and 2 dB when the antenna is operated without foreign material on the antenna.

13. An antenna heater system, comprising:
an antenna heater, comprising a heating panel, configured for attachment to an antenna and comprising heating tracks, wherein the heating tracks are spaced apart from each other and each comprises an electrically-conductive trace and positive temperature coefficient (PTC) elements, and wherein the PTC elements are electrically connected to the electrically-conductive trace, spaced apart along the electrically-conductive trace, and made of a PTC material having an equilibrium temperature greater than 0° C.;
a temperature sensor, configured to detect temperature of air external to the antenna heater;
a humidity sensor, configured to detect relative humidity of air external to the antenna heater; and
a control module, configured to supply electrical power to the electrically-conductive traces of the heating tracks, such that the PTC elements of the heating tracks generate heat, only when the temperature of the air detected by the temperature sensor is below a temperature threshold and the relative humidity of the air detected by the humidity sensor is above a humidity threshold.

14. The antenna heater system according to claim 13, wherein:
the temperature threshold is between 1° C. and 10° C., inclusive; and
the humidity threshold is between 50% and 100%, inclusive.

15. The antenna heater system according to claim 14, wherein the equilibrium temperature of the PTC material of each one of the PTC elements is greater than 10° C. and less than 35° C.

16. The antenna heater system according to claim 13, wherein the control module is further configured to continuously increase a current of the electrical power from zero to a maximum current over a predetermined time interval in response to the temperature of the air detected by the temperature sensor being below the temperature threshold and the relative humidity of the air detected by the humidity sensor being above the humidity threshold.

17. A method of preventing ice formation on an antenna, the method comprising a step of:
activating an antenna heater, mounted to the antenna, to supply heat to the antenna only when air, around the antenna, has a temperature below a temperature threshold and has a relative humidity above a humidity threshold, wherein activating the antenna heater comprises heating positive temperature coefficient (PTC) elements of the antenna heater up to an equilibrium temperature of PTC material of the PTC elements.

18. The method according to claim 17, wherein:
the antenna is a drum antenna comprising a hollow base, defining a signal transmission opening through which electromagnetic waves are transmitted from the drum antenna and received by the drum antenna, and an external cover that covers the signal transmission opening and encloses the hollow base; and
the method further comprises a step of mounting a heating panel of the antenna heater onto the hollow base such that the heating panel covers the external cover.

19. The method according to claim 18, wherein the step of mounting the heating panel of the antenna heater onto the hollow base comprises:
receiving a first portion of an outer ledge of the antenna into a first-clamp-arm channel of a first clamp arm of the antenna heater;
receiving a second portion of the outer ledge of the hollow base into a second-clamp-arm channel of a second clamp arm of the antenna heater; and
when the first portion of the outer ledge is received into the first-clamp-arm channel and the second portion of the outer ledge is received into the second-clamp-arm channel, locking together the first clamp arm and the second clamp arm.

20. The method according to claim 19, wherein the heating panel is fixed to the first clamp arm, such that the heating panel does not move relative to the first clamp arm and such that the heating panel is moved into position over the external cover of the antenna as the first portion of the outer ledge is received into the first-clamp-arm channel.
